(19) United States
(12) Patent Application Publication
(10) Pub. No.: US 2010/0293881 A1
(43) Pub. Date: Nov. 25, 2010

(54) COMPOSITE FRAME FOR INSERTION IN A BUILDING APERTURE

(76) Inventors: Holger Betz, Albstadt (DE); Rolf Pfeffer, Starzach-Bierlingen (DE); Ralf König, Renchen (DE); Jan Knippers, Stuttgart (DE); Stefan Peters, Stuttgart (DE)

Correspondence Address: SHLESINGER, ARKWRIGHT & GARVEY LLP, 5845 Richmond Highway, Suite 415, ALEXANDRIA, VA, 22303, US

(21) Appl. No.: 12/309,673

(22) PCT Filed: Jul. 25, 2007
(86) PCT No.: PCT/EP2007/006607

§ 371 Date: Dec. 11, 2009

(30) Foreign Application Priority Data
Jul. 28, 2006 (DE) 10-2006-036-138.5

(51) Int. Cl. E04C 2/38; E06B 3/22; E06B 7/16

(52) U.S. Cl. 52/656.2; 52/656.5; 52/656.4; 52/745.15

(57) ABSTRACT

A composite frame (110) for insertion in a building aperture comprises a blind frame (112) and a sash frame (114) hinged to the blind frame (112), wherein the sash frame (114) has an inner sash frame profile (116) and on an outward facing side of the inner sash frame profile (116) is provided an adapter profile (118) fixedly connected to the inner sash frame profile (116) for fixedly inserting a panel (120) provided for this purpose. The blind frame (112) comprises an inner blind frame profile (122) essentially surrounding the inner sash frame profile (116) and on a side of the inner blind frame profile (122) on the outside of the building is provided an outer visible part (124) fixedly connected to the inner blind frame profile (122).

The present invention relates to a composite frame for insertion in a building aperture, particularly a window or door aperture. In particular, the present invention relates to a window or door frame which is made up of different materials by composite materials technology.

Window and door frames are traditionally made of wood, metal or plastics. In recent years, there has been increasing use of window frames made of glass fibre-reinforced plastics (GRP), and composite window frames made of wood and aluminium are also known.

Typically, in window manufacture, double glazing panels are wedged in a frame made of wood, plastics of aluminium. The window aperture sashes are made rigid by the wedging of the panels in the frame. The forces thus produced in the frame are transmitted via the corners of the frame and determine the dimensions thereof. In wood-aluminium composite frames the wooden frames are protected from weathering by an external aluminium frame, while the high heat conductivity of aluminium leads to undesirable thermal bridges in the cross section of the frame.

From EP 0586213 A1, a composite material consisting of polymer and wood fibres is known, which can be extruded to form a window frame.

In contrast thereto, the invention proposes a composite frame and an adapter profile for a window or a door with a very small frame cross-section, i.e. with a small visible width of the frame.

The composite frame according to the invention has a first frame section which is fixed (in the installed state). Hinged to this first frame section is a second, openable frame section. The openable second frame section in turn comprises an inner sash profile (i.e. one which faces into the interior of the building in the installed position). On a side facing outwards (again in relation to the installed position), i.e. the weather or weathering side, of the inner sash profile is provided an adapter profile which is firmly connected to the sash profile and serves to firmly accommodate a window pane provided for this purpose.

The first fixed frame section (in closed state) has an inner blind frame profile which substantially surrounds the inner sash profile of the openable second frame section. On a side of the surrounding inner blind frame profile facing the exterior of the building there is an outer visible section fixedly connected to the surrounding inner blind frame profile.

In the art the fixed first frame section is known as the blind frame and the openable second frame section is known as the sash or sash frame. These terms are used hereinafter. Accordingly, the profile of the blind frame arranged on the inside of the building is referred to as the inner blind frame profile and the profile of the sash arranged on the inside of the building is referred to as the inner sash profile.

The window panel and the adapter profile may be joined together substantially peripherally, so that the adapter profile together with the pane forms a self-supporting rigid unit. This fixed connection may be achieved for example by gluing the pane to the adapter profile or by some other suitable connecting method.

Moreover, the fixed connection of the adapter profile to the inner sash profile and the fixed connection of the outer visible portion to the inner blind frame profile may be achieved for example by gluing and/or screwing. However, other suitable forms of attachment are also possible.

A panel which has been wedged in the conventional manner requires, for example, a surrounding frame which provides a stiffening and supporting function and has to be of suitable dimensions. In contrast thereto, the fixedly attached unit comprising the adapter profile and panel of itself forms a rigid self-supporting unit which can be fixedly attached to the sash profile. In this way the dimensions of the sash profile are determined substantially less by the reinforcing function and more by the need to accommodate the usual fittings for a window. As a result the reduction in the dimensions of the sash profile is limited by the fittings used. The inner blind frame profile also provides for the accommodation of fittings and its dimensions are therefore also essentially determined by this function.

In this way the visible surface of the sash profile on the inside of the building and of the blind frame profile can be reduced. The phrase “visible surface on the inside of the building” refers to the surface of the composite frame which defines the composite frame in the interior direction and provides the aspect seen by an observer in the building. The two frame profiles may consequently be made significantly slimmer than in comparable conventional window frames and therefore make it possible to have a larger window area for a given building aperture as the frame part of the window is reduced.

In contrast to conventional window frames with a wedged-in panel and a so-called air rebate, when the panel or pane is fixedly attached to the adapter profile a comparatively thin layer of adhesive is applied which both reduces the construction space needed and is also barely perceptible owing to its thinness in the visible areas and therefore does not detract from the aesthetic effect on an observer. Moreover, the rigid unit of panel and adapter profile produced by the fixed connection allows the panel to be positioned immovably in the composite frame. In contrast thereto, when the window sash is subjected to severe impact, such as when the sash is banged shut, the pane in a conventional window frame wherein the pane is wedged in position is moved relative to the window frame.

As outlined above, the blind frame profile and the sash profile essentially perform the function of accommodating the fittings usually provided on a window or attaching the unit comprising the pane and adapter profile to the fittings. Moreover, the two profiles form the visible surface of the composite frame on the inside of the building and therefore have to meet high aesthetic requirements.

For this purpose, the blind frame profile and the sash profile may be selected for example from a group consisting of wood, plastics such as PVC, fibre-reinforced plastics such as glass fibre-reinforced plastics (GRP) or carbon fibre-reinforced plastics (CFRP), mineral materials or wood composite such as for example Fibrex™ made by Messrs Anderson. Surface coatings of these materials on a frame profile made from a suitable material are also possible.

Depending on the choice of materials for the blind frame profile and the sash profile, a unified appearance on the interior side can be obtained by using the same material or by using uniform or apparently uniform materials or surfaces. However, the choice of materials is not restricted to the choice of the same material for the blind frame profile and the sash profile; rather, different materials can be used for the different profiles, but as a result of this the appearance of the inner surface or visible surface may not be uniform.

According to another embodiment, both the blind frame profile and the sash profile are made of wood and in this way a slender frame is produced with uniform visible surfaces on the side facing the room.

The outer visible part essentially delimits the composite frame completely on the exterior side of the building. The outer visible part is attached to the inner blind frame profile and has a surface on the outside of the building which is preferably the only surface of the composite frame which is open to the weather or exposed to weathering. For this purpose the outer visible part extends over the adapter profile, for example, and is adjacent to the window pane.

In this way a uniform appearance of the composite frame is obtained on the outside of the building as only the outer visible part of partial sections of the outer visible part and the window pane are visible from outside. Particularly in the case of building facades with a number of windows or large areas of glass or window facades which essentially consist of windows placed side by side, this uniform appearance is desirable.

Apart from an openable composite frame it is also possible to construct a fixed, non-openable composite frame (a so-called fixed area). As the composite frame is entirely covered by the outer visible part and is very slender in construction, the openable composite frame and the fixed area have a comparable frame thickness, or may be produced with the same or an essentially similar frame thickness without the composite frame of the fixed area having to be made wider or substantially wider, as is the case in conventional window frames, by contrast. In this way, there is no visible difference from outside the building between an openable composite frame and a fixed area. Particularly in the case of building facades which have both openable windows and fixed areas it is thus possible to achieve a uniform appearance of the individual windows from outside the building and if desired a uniform appearance of glass or window facades.

For sealing the composite frame, a first surrounding seal, for example a seal with a sealing lip, may be provided on the outer visible part, on an edge of the outer visible part close to the window pane. The first seal may be disposed between the outer visible part and the pane such that in the closed position of the composite frame the first seal or optionally its sealing lip structurally acts on the window pane and/or on the adapter profile. The first seal thus provides a sealing connection between the window pane and the outer visible part or between the adapter profile and the window pane and in this way seals the outer visible part relative to the window pane or relative to the adapter profile.

For accommodating the seal on the outer visible part, a groove may be provided thereon, for example, in which the seal can be inserted or attached in a suitable manner. For this purpose, for example, a groove may be provided on the portion of the outer visible part closest to the window pane, the opening of said groove facing substantially towards the interior of the building. A first seal with a sealing lip which structurally engages with the window pane in the closed position of the composite frame can be secured therein. However, other conventional means of forming a seal with the outer visible part are also possible.

In this way, the sealing lip abutting on the window pane forms, together with the outer visible part, a closure for the composite frame on the weather side.

According to another embodiment, the outer visible part may have an insulating cavity or may be constructed as a hollow chamber profile. The hollow chamber may be filled with air or a thermal insulation material selected from the group comprising gases, insulating foam such as polyurethane foam, for example, insulating wool or other suitable heat insulating materials. In this way the heat conductivity of the outer visible part can be further reduced. The hollow chamber is arranged for example in the region of the connection to the blind frame profile and reduces the heat conduction of the outer visible part particularly to the inner blind frame profile on the side facing the room. Thus the formation of thermal bridges can be reduced or prevented.

Of course, it is also possible to have embodiments with an outer visible part without an insulating core or hollow cavity.

The outer visible part may be made essentially of a material selected from among plastics such as PVC, fibre-reinforced plastics, e.g. glass fibre-reinforced plastic (GRP) and carbon fibre-reinforced plastics (CFRP), mineral materials, wood composite such as Fibrex™ made by Messrs Anderson or a metal or a metal alloy, particularly aluminium or aluminium alloys. However, other materials are also possible which are capable of withstanding the stresses of weathering and can be shaped or produced in a suitable manner. An outer visible part made of a GRP composite material is known for example from EP 0586213A1.

According to one possible embodiment the use of glass fibre-reinforced plastics (GRP) to produce the outer visible part is envisaged. GRP, in addition to having high strength and weathering resistance, has comparatively low heat conductivity, which means that the overall heat conductivity of the frame can be reduced, in addition to a possible construction with an insulating cavity. Moreover, the low heat expansion of the fibre-reinforced plastics mentioned previously allows direct and easy attachment to the adjacent inner blind frame profile. This fixed connection can be made as already described, for example, by screwing and/or adhesive bonding or some other suitable method. There is no need to uncouple the outer visible parts to take account of varying thermal expansions and to prevent thermal bridges between the inner blind frame profile which is made of wood, for example, and the outer visible part made of GRP. In addition, the GRP prevents the formation of thermal bridges, so that uncoupling is not needed to take account of this aspect either.

The proposed adapter profile which can be used, for example, in a composite frame as described hereinbefore is intended for fixed connection to a window pane and for fixed connection to a sash profile.

For this purpose a cross section of the adapter profile according to one possible embodiment has a middle section for connecting the adapter profile to the window pane and at least one first leg for connecting the adapter profile to the sash. The first leg may for example be arranged at a first end of the middle portion.

The first leg may be arranged on the middle portion such that a substantially L-shaped or T-shaped cross-section is obtained for the adapter profile.

Moreover, the adapter profile may be constructed according to one embodiment for the mounting of a second seal which seals the adapter profile against a blind frame surface of the composite frame. For this purpose it is possible to provide a groove to accommodate the second seal or other suitable means.

In addition, the adapter profile may have a second leg which is arranged at a second end of the middle portion opposite the first end.

For example, the second leg may be arranged on the middle portion such that the adapter profile essentially has a Z-shaped, U-shaped or h-shaped cross-section. The h-shaped cross-section is a combination of the Z-shaped and U-shaped cross-sections.

The second leg adjoins the surface of the window pane on the outside of the building, corresponding to the cross-sections mentioned above. The bent cross-sections reinforce the adapter profile and make it possible to construct the rigid self-supporting unit comprising the adapter profile and window panel.

Of course, different variations of the cross-sections shown or differently constructed cross-sections for the adapter profile are also possible.

The first leg is connected, for example, to the inner sash profile. According to the cross-sectional shapes shown, the first leg extends substantially in one plane parallel to the window surface on the room side. The first leg thus has a surface on the inside of the building by means of which the adapter profile can be attached to the inner sash profile. As described above, this can also be achieved by means of screwing and/or adhesive bonding or by other suitable means.

The connection of the adapter profile to the inner sash profile may be made such that the window panel is not in contact with the inner sash profile but is spaced therefrom and a gap is formed between the two elements. A suitable insulating material may be arranged in this gap, for example, in order to insulate the sash profile from the window panel.

According to one possible embodiment the adapter profile is made from a material which only has a very low thermal expansion or a thermal expansion essentially corresponding to the window panel, so as to enable the adapter profile to be attached to the window panel in a fixed or rigid manner and substantially around its periphery without any tensions occurring in or between the individual elements. Using a high strength rigid material it is also possible to construct different thin walled cross sections for the adapter profile.

The adapter profile is therefore preferably made from a material selected from among fibre-reinforced plastics such as for example glass fibre-reinforced plastics (GRP) and carbon fibre-reinforced plastics (CFRP). Apart from being strong these materials have the property of a low thermal expansion coefficient or of an expansion coefficient which is close to the thermal expansion of a pane of glass.

The proposed groove close to the first leg for accommodating a second seal may for example be formed by the first leg and an extension arranged parallel to the first leg on the adapter profile. The direction of opening of the groove thus runs parallel to the alignment of the first leg. Alternatively, the groove may also be formed on the first leg in some other suitable manner and/or be aligned in a different direction, so that it is able to seal off the adapter profile relative to a blind frame surface of the composite frame.

A second seal, for example a seal with a sealing lip, may be secured in this groove in suitable manner. The second seal or optionally its sealing lip extends up to the outer visible part nearest to it and structurally engages with a surface of the outer visible part arranged within the composite frame and thus seals the adapter profile relative to the outer visible part. The arrangement of the second seal between the adapter profile and the outer visible part thus counteracts the formation of thermal bridges.

According to another possible embodiment, both the outer visible part and the adapter profile are made of glass fibre-reinforced plastics. In this embodiment very low heat conductivity is achieved, which substantially reduces or prevents the formation of any thermal bridges by the arrangement of the second seal between the adapter profile and the outer visible part.

According to another embodiment, an inner side surface of the sash profile and an edge surface of the outer visible part and/or an edge surface of the first seal are arranged substantially in the same plane, so that a common plane extending through the window panel or a frame apparently extending through the window panel is formed. The inner side surface of the sash profile constitutes the surface of the sash profile adjacent to the window panel.

This means that there is essentially no perceptible step between the two surfaces so that to the observer the surface appears continuous, interrupted only by the window panel and thus in particular aesthetic ideas can be accommodated. A stepped construction and possible protrusions of the adapter profile or sash profile projecting into the transparent part of the window frame from this apparently continuous surface can thus be avoided, i.e. the first seal and/or the sash profile are prevented from protruding significantly into the transparent area of the window panel and being visible from the opposite side. This is usually the case, particularly where seals are applied to the window panel, and is generally found unattractive by an onlooker.

According to another embodiment the arrangement of the side surface of the sash profile and the edge surface of the outer visible part described above can be achieved by having the visible surface of the composite frame on the inside of the building and on the weathering side made to be substantially the same size. This means that the surface of the outer visible part on the exterior of the building, optionally with a protruding seal or sealing lip, is the same size as the visible surfaces of the sash frame and blind frame profile together in the direction of the interior of the building (when the composite frame is closed). In cross-section through the composite frame this corresponds to the same height of the outer visible part including any first seal provided and the sash frame together with the adjacent blind frame profile.

According to one embodiment the invention provides a weather-proofed frame profile for windows or doors which on the room side is made of wood, for example, and thus meets high requirements as to the building construction. Thanks to the reinforcing load-bearing construction of the sash wood frame by means of the surrounding window profile made of GRP, for example, fitted on from the outside and fixedly attached to the wooden sash frame, it is possible to construct a frame with a very narrow apparent width (slender frame), so that modern designer aspirations can be met. Because of the use of glass fibre-reinforced plastics, for example, for the window profile and the outer visible part, the thermal transfer coefficient of the composite frame is improved by comparison with a wood/aluminium window. Thanks to the low heat conduction of GRP, no thermal bridges are formed in the cross-section of the frame.

According to another embodiment it is possible to connect the window fittings directly to the adapter profile. In this way it is possible for example to dispense with the use of at least the sash profile and thus make the frame even more slender in construction. It goes without saying that the adapter profile does not have to enclose the frame completely or substantially. Rather, the adapter profile may also partially surround or be connected to the window panel only in a desired number of partial areas, such as for example in the region where the load is supported through the window fittings. This means that the essentially surrounding adapter profile may have any desired number of interruptions. It is also possible to mount fittings, comparable to a frameless glass door, in which the fittings are mounted on the window panel at a spacing from the edge and there is no need for an adapter profile (partially) surrounding the edge of the panel.

Obviously, in every case, a suitable seal must be provided for the window panel, while suitable constructions of a sealing arrangement will be familiar to anyone skilled in the art of window and door construction.

According to another embodiment, it is possible to use an adapter profile with a window panel without a blind frame. The panel is connected to the adapter profile substantially around its periphery or at any desired number of separate areas and the adapter profile may be directly or indirectly connected to the building.

Further advantages and features of the invention will become apparent from the description, the subsidiary claims and the attached drawings.

It will be understood that the features mentioned hereinbefore and those which are yet to be described may be used not only in the particular combination specified but also in other combinations or on their own without departing from the scope of the present invention.

The invention is diagrammatically illustrated in the drawings by means of embodiments by way of example and is described in detail hereinafter with reference to the drawings.

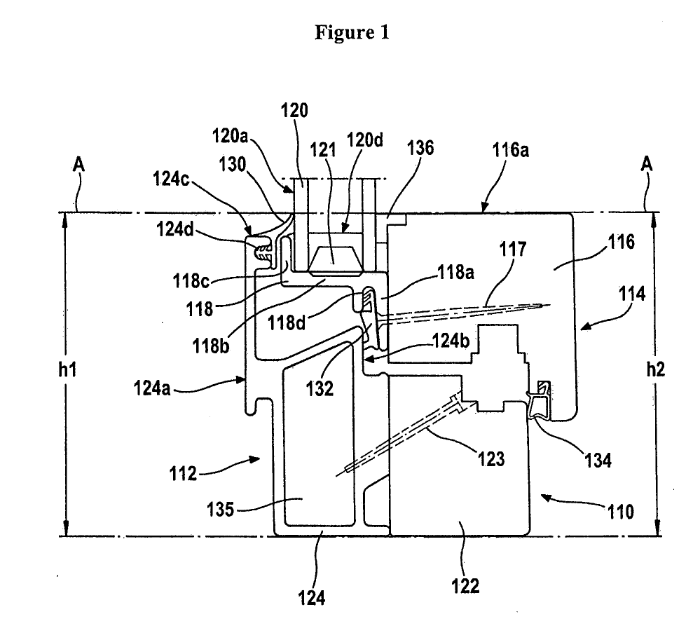

FIG. 1 shows a cross-section/vertical section through a first embodiment of a window with a composite frame according to the invention.

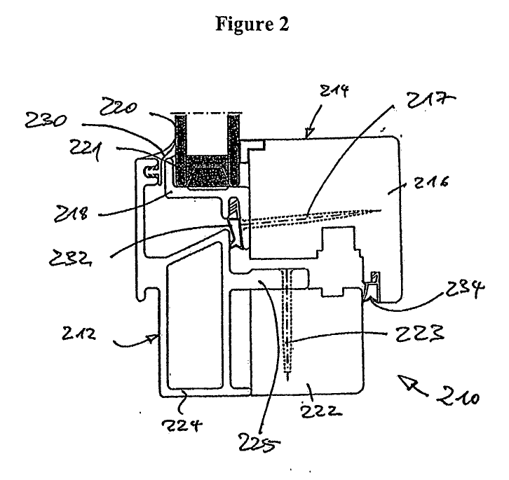

FIG. 2 shows a cross-section, similar to FIG. 1, through a second embodiment of a window having a composite frame according to the invention.

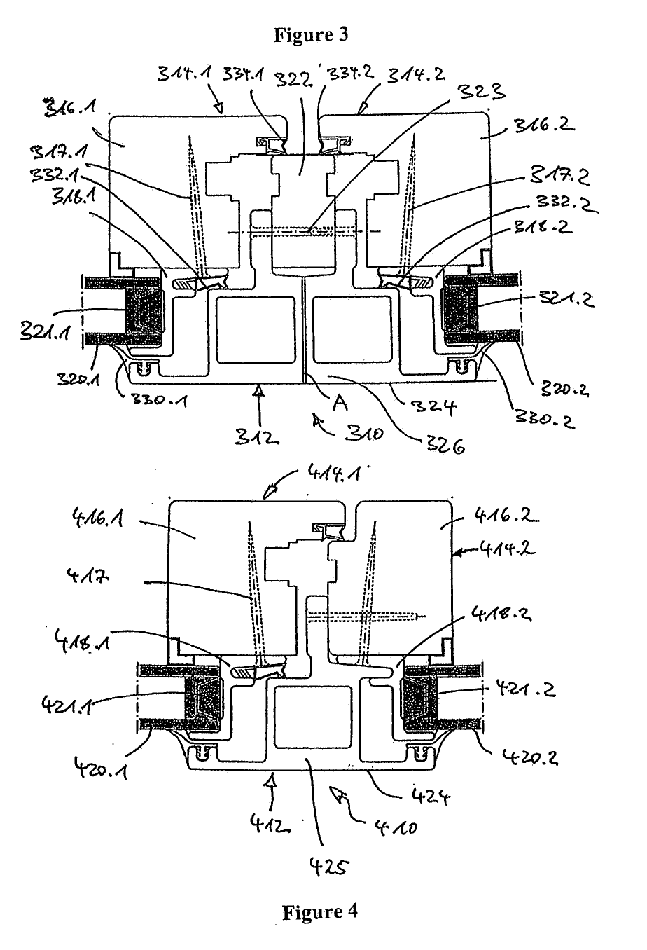

FIG. 3 shows a horizontal section through a composite frame according to the invention, which integrates to adjacent windows, in the region of the post.

FIG. 4 shows a horizontal section through another embodiment of a composite frame according to the invention with two windows arranged side-by-side, the section extending through the face-plate region.

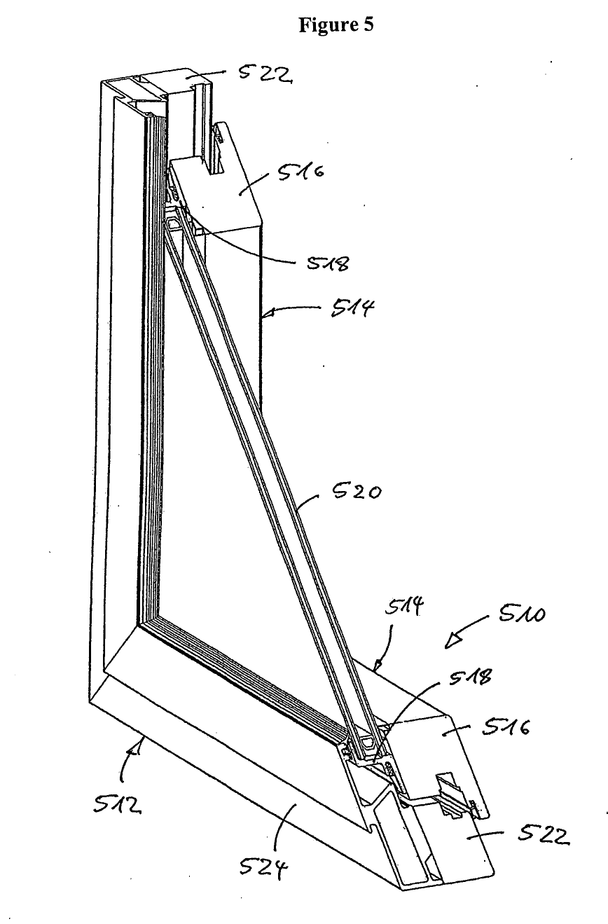

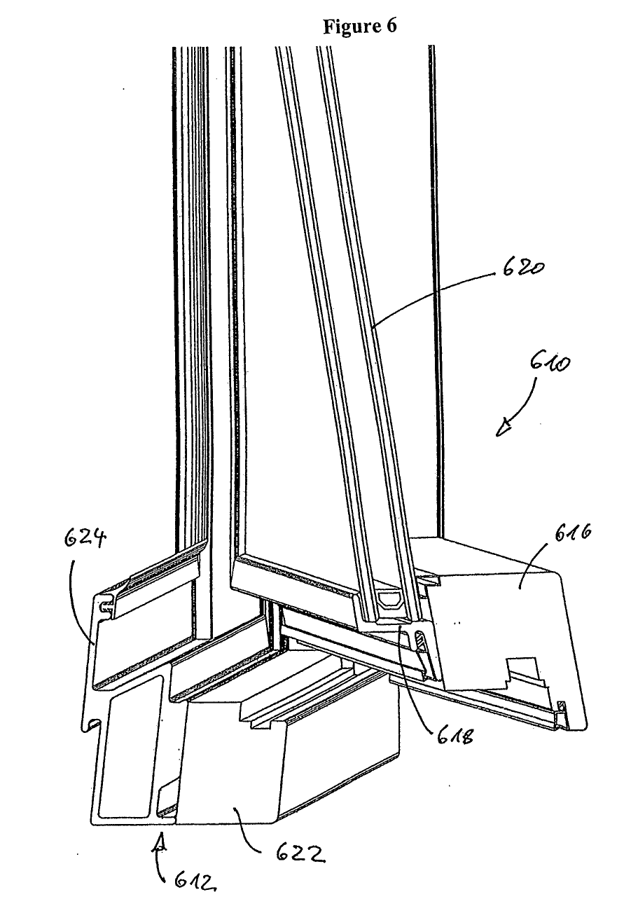

FIG. 5 is a schematic perspective partial view of a section through the window in FIG. 1 in the closed state.

FIG. 6 shows the window in FIG. 5 in a perspective sectional view in the open state.

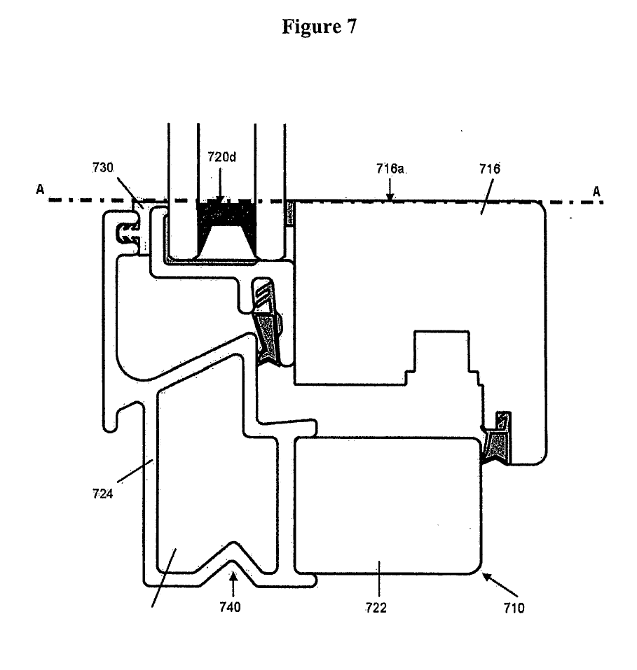

FIG. 7 shows a cross-section similar to FIG. 1 through another embodiment of a composite frame according to the invention with a frame apparently extending through the window panel.

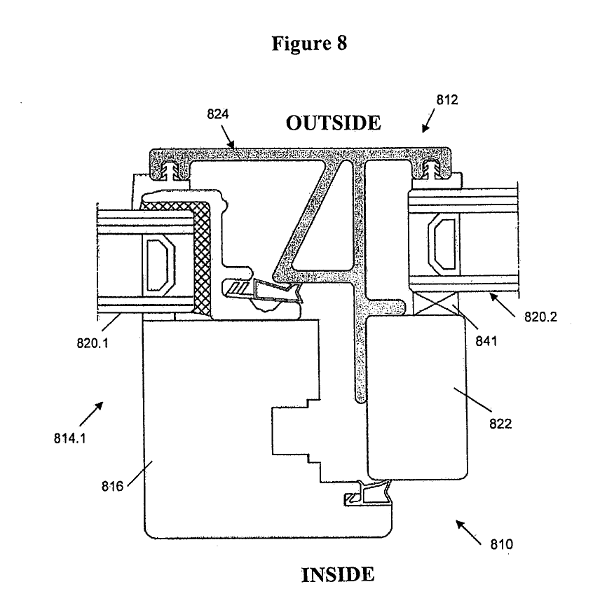

FIG. 8 shows a horizontal section through another embodiment of a composite frame according to the invention with an openable window and an adjacent fixed area in which the section runs through the region of the post.

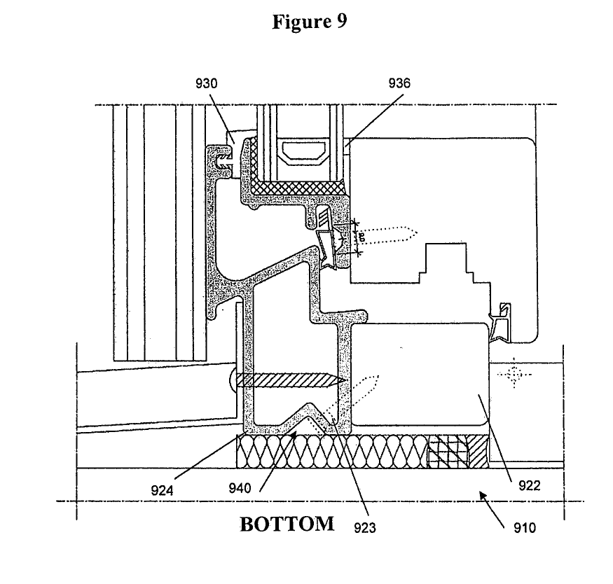

FIG. 9 shows a cross-section/vertical section similar to FIG. 1 through another embodiment of a window having a composite frame according to the invention, in the installed state.

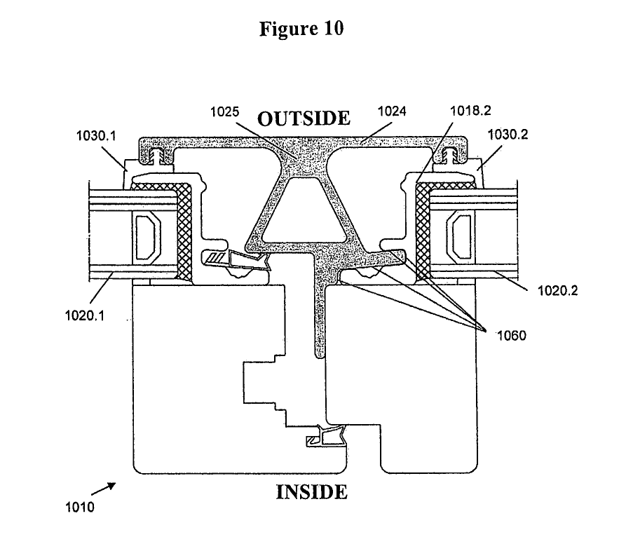

FIG. 10 shows a horizontal section similar to FIG. 4 through another embodiment of a composite frame according to the invention with two adjacent windows, wherein the section runs through the face-plate region.

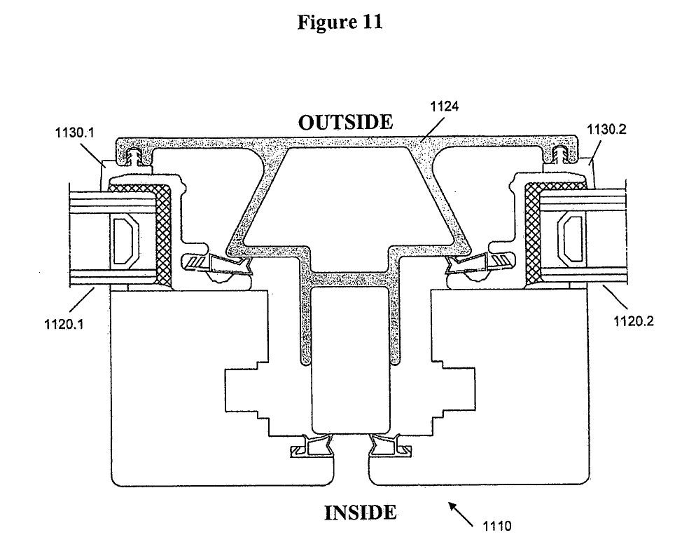

FIG. 11 shows a horizontal section similar to FIG. 3 through a composite frame according to the invention which integrates two adjacent windows in the region of the post.

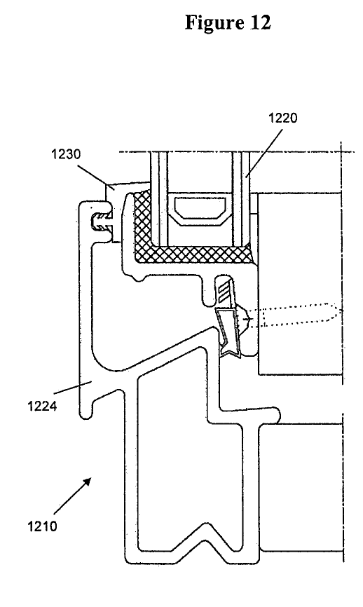

FIG. 12 shows a cross-section/vertical section similar to FIG. 9 through another embodiment of a window having a composite frame according to the invention and a double glazing panel.

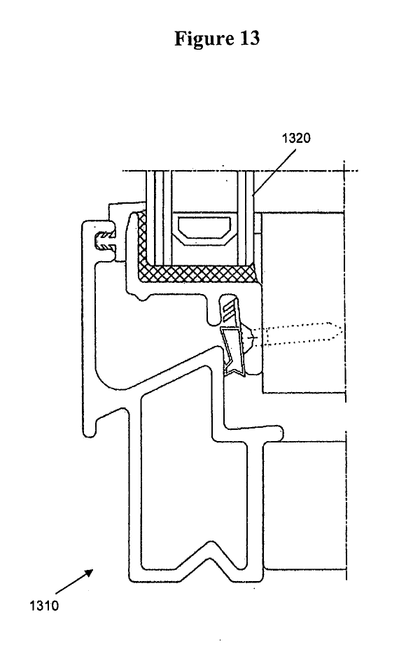

FIG. 13 shows a cross-section/vertical section similar to FIG. 12 through another embodiment of a window having a composite frame according to the invention and a double glazing panel which is additionally insulated on the outside of the building.

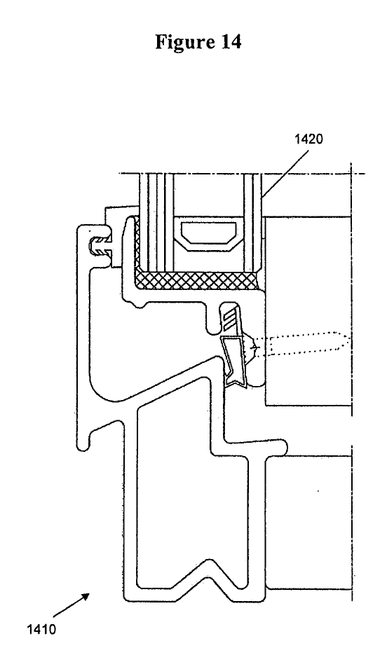

FIG. 14 shows a cross-section/vertical section similar to FIG. 13 through another embodiment of a window having a composite frame according to the invention and a double glazing panel which is additionally insulated on the outside of the building.

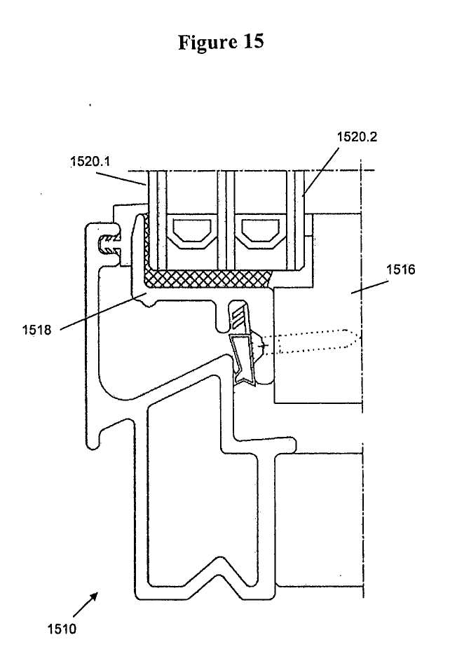

FIG. 15 shows a cross-section/vertical section similar to FIG. 12 through another embodiment of a window have having a composite frame according to the invention and a double glazing panel with two chambers.

FIG. 1 shows a first embodiment of a composite frame 110 according to the invention. The composite frame according to the invention is suitable for fitting in a building aperture, particularly a window or door aperture. The installation may be in a vertically perpendicular position or at an angle (for example as a roof window). Naturally it is also possible to have an installation which is oriented in a different spatial direction such as, for example, a substantially horizontal installation.

The composite frame according to the invention comprises a blind frame 112 facing towards the exterior of the building and a sash frame 114 hinged to the blind frame 112. Usually, the sash frame 114 is hinged to the blind frame 112 by means of hinges so that it can be pivoted horizontally. In many cases the hinge mechanism for jointing the sash frame 114 to the blind frame 112 is configured such that the sash frame can also be opened relative to the blind frame into an inclined sloping position (angle inclined to the vertical). Naturally, the sash frame may also be in the form of a “sliding frame” or fixed (non-openable) frame without departing from the scope of the invention.

According to the invention the sash frame 114 comprises a sash profile 116 on which is mounted an adapter profile 118 in the direction of the exterior of the building (i.e. on an outwardly facing side of the sash profile 116). The adapter profile 118 consists, in the embodiment shown, of glass fibre-reinforced plastics, for example, and is fixedly connected to the sash profile 116. In the example illustrated in FIGS. 1 to 4, the fixed connection is achieved by means of screws 117. Alternatively the fixed connection may also be obtained by gluing or by screwing and gluing. Other methods familiar to window designers for providing a fixed connection between the sash profile which is made of wood in the embodiment shown and the adapter profile made of glass fibre-reinforced plastics may also be used.

The adapter profile 118 has a substantially Z-shaped cross-section with a first leg 118a and a second leg 118c and a middle portion 118b which joins the two legs 118a, 118c.

The first leg 118a and second leg 118c are each bent substantially at right angles to the middle portion 118b, the second leg 118c and the middle portion 118b being fixedly connected to the window panel 120 or a heat insulating edge seal 121 on the panel and a weather-side surface 120a of the panel 120. The first leg 118a is connected to the inner sash profile 116.

The essentially Z-shaped cross-section of the adapter profile 118 has an extension arranged parallel to the first leg 118a and a groove 118d formed between the first leg and the extension, for receiving a second seal 132 with a sealing lip. The opening of the groove 118d is directed parallel to the first leg 118a in the embodiment shown. The sealing lip acts structurally on a surface 124b of the outward visible part 124 arranged within the composite frame 110 and seals off the adapter profile 118 relative to the external visible part 124.

The blind frame 112 is also formed essentially in two parts and comprises a blind frame profile 122 which essentially surrounds the sash profile 116 of the sash frame 114. In addition, the blind frame 112 comprises an outward visible part 124 which according to the invention in the embodiment shown consists of glass fibre-reinforced plastics (or a composite material essentially containing glass fibre-reinforced plastics). The outer visible part 124 facing the exterior of the building and made of glass fibre-reinforced plastics (GRP) is fixedly connected to the wooden blind frame 122. The fixed connection can be achieved by means of screws 123 or by gluing or by gluing/screwing or any other method of connection which is suitable in window constructions, as shown in the case of the sash frame 114 and illustrated by way of example in FIGS. 1 to 4.

The outer visible part 124 is constructed so as to substantially delimit the composite frame 110 completely on the exterior side and is adjacent to the window panel 120, so that essentially a surface 124a of the outer visible part 124 on the outside of the building is the only surface of the composite frame which is open to the weather or exposed to weathering.

For accommodating a first seal 130 with a sealing lip, a groove 124d into which the first seal 130 is inserted is provided on the part of the outer visible part nearest the window panel. The opening of the groove 124d faces essentially towards the interior of the building. In the closed state of the composite frame 110 shown, the sealing lip structurally engages with the window panel 120 and seals off the outer visible part 124 from the panel 120. The sealing lip 124d abutting on the panel 120 thus forms, together with the outer visible part 124, the seal for the composite frame 110 on the weather side.

In order to complete the composite frame 110 according to the invention before fitting it into the building aperture provided for this purpose, a panel 120 is inserted in the adapter profile 118 made of GRP and fixedly attached to it, for example by gluing it along its periphery at all four edges of the panel 120. Naturally, other shapes of panel are possible such as round or polygonal shapes, for example. The panel 120 is, in particular, a double glazing panel. The panel 120 may be made of glass or some other suitable material. By being fixedly connected to the adapter profile 118, particularly by gluing, the panel 120 is used to reinforce the sash frame arrangement 114, so as to obtain a rigid and self-supporting unit. The rigid and hence load bearing connection of the adapter profile 118 to the sash frame profile 116 renders the sash frame profile 116 rigid by means of the panel 120. As illustrated by way of example in FIGS. 1 to 4, the double glazing panel 120 has a thermally insulating edge seal 121 (made for example of plastics (PVC) or some other suitable material). As an alternative to a heat insulating edge seal it is naturally also possible to have a conventional edge seal. Obviously, embodiments with insulating glass with more than one chamber are also possible.

The fixed frame section of the composite frame according to the invention is formed, as already explained, by the blind frame 112 which consists of the internal blind frame profile 122 and the outer visible part 124. The blind frame 112 and the sash frame 114 meet at three sealing planes in the closed state in the embodiments shown, namely an external seal 130 between the outer visible part 124 and the panel 120, an intermediate seal 132 between the outer visible part 124 and the window profile 118, and an inner seal 134 between the sash profile 116 and the blind frame profile 122. The illustration with three sealing planes is provided by way of example; the window fitter or manufacturer knows that at least one sealing plane must be provided between the two frame sections that are movable relative to one another (primarily the plane shown here as the middle sealing plane) and that in addition to this any number of sealing planes are possible (two, three, four or even more).

The outer visible part 124 of the blind frame 112 is designed as a hollow profile with a cavity 135 which may be provided with an insulating core in order to improve the heat transfer coefficient of the composite frame.

An inner side surface 116a of the sash profile 116 and an edge surface 124c of the outer visible part or an edge surface of the first seal 130 meet flush with one another substantially at the same height (characterised by the line A-A), thereby forming a frame which apparently extends through the window panel 120.

The appearance of the frame extending through the panel is achieved in the embodiment shown by a suitable construction of the outer visible part 124 and the seal 130 and of the sash frame profile 116 and blind frame profile 122, which is characterised by free visible surfaces of the same size both in the interior of the room and of the outside of the building (represented by the height of the composite frame h1 on the outside of the building and the height h2 on the room side).

According to an embodiment shown in FIG. 5, an inner surface 120d of the edge seal of the panel is additionally arranged substantially on or slightly below the height A-A. This produces an apparently continuous surface extending through the panel.

Moreover, in FIG. 1, the panel 120 is arranged at a spacing from the inner sash profile by means of the adapter profile 118, in the embodiment shown, and a gap is provided between the two elements. This gap is sealed off by insulation 136 at least at the upper edge of the gap. Naturally, the insulation may also fill the gap completely.

FIGS. 2 to 4 and 7 show further embodiments of composite frames according to the invention, and FIGS. 5 and 6 show a perspective sectional view of the composite frame of FIG. 1 in the closed and opened states, respectively. The three-digit reference numerals indicate the number of the Figure by the first digit and the identical sequences of two numbers following the first digit denote identical or similar elements in the various Figures.

FIG. 5 shows a composite frame 510 according to the invention, comparable with FIG. 1, in perspective sectional view, and FIG. 6 shows the composite frame of FIG. 5 in perspective sectional view, in the opened state.

FIG. 2 shows a composite frame 210 similar to the embodiment in FIG. 1, having a blind frame 212 and a sash frame 214, which meet at a total of three sealing planes 230, 232, 234 in the closed state. The main difference between the composite frame 210 in FIG. 2 and the composite frame 110 in FIG. 1 is that the blind frame profile 222 in FIG. 2 is attached to a profile section 225 bent away from the outer visible part 224 towards the interior of the building, in a different manner from that shown in the embodiment of FIG. 1.

FIG. 3 shows a horizontal section through a composite frame 310 according to the invention, which integrates two adjacent windows. The horizontal section in FIG. 3 shows a post 326 of the blind frame 312 (as part of the outer visible part 324). The composite frame in FIG. 3 comprises a first sash frame 314.1 (shown on the left in FIG. 3) and adjacent to it a second sash frame 314.2 with corresponding window panes 320.1, 320.2. Each of the sash frames 314.1, 314.2 is formed according to the invention from a sash profile 316.1, 316.2 and an adapter profile 318.1, 318.2 fixedly connected to the sash profile 316.1, 316.2.

The blind frame 312 of the composite frame 310 of FIG. 3 comprises a blind frame profile 322 which is fixedly connected to the outer visible part 324, which essentially surrounds the sash frame profile 316.1, 316.2 and forms a post in the region between the two sash profiles 316.1, 316.2 (see the sectional view in FIG. 3). The fixed connection between the blind frame profile 322 and the outer visible part 324 is achieved for example by screwing 323. In visual terms, the frame arrangement in FIG. 3 is a mirror-image duplication of the individual frame in FIG. 1, with the axis marked A in FIG. 3 as the axis of symmetry.

FIG. 4 shows a horizontal section through another embodiment of a composite frame according to the invention. The composite frame 410 shown in FIG. 4 is designed to accommodate two windows arranged side-by-side which adjoin one another via a face-plate 425 of the outer visible part 424 of the blind frame 412. In the embodiments shown in FIG. 4, only one of the two windows (the window shown on the left in FIG. 4) with the sash frame 414.1 can be opened, whereas the window to its right has a “sash frame” 414.2 which is fixedly attached to the blind frame 412 and is thus fixed and not openable (an arrangement of this kind is conventional in door construction, for example, with an openable glass door and a fixed window adjacent to it). Obviously, the “fixed sash frame” 414.2 in the embodiment shown in FIG. 4 may also be designed to be openable; this would mean that it can only be opened when the left-hand sash frame 414.1 overlapping it on the interior side has already been opened.

The composite frame 410 in FIG. 4 differs from the embodiment shown in FIG. 3 inasmuch as the blind frame profile is constructed to surround the two sash frame profiles 416.1, 416.2 and is therefore not visible in the detailed view in FIG. 4, as there is no blind frame profile in the region of the face-plate 425 where the two sash profiles 416.1, 416.2 meet. In other words it could also be said that in the region of the face-plate 425 the “fixed sash profile” 416.2 takes on the function of the blind frame profile, as it is fixedly connected to the outer visible part 424 in the embodiment shown (however, this approach does not apply in the case of an openable right-hand sash frame 414.2).

FIG. 7 shows a cross-section through another embodiment of a composite frame according to the invention with a frame extending through the panel, substantially comparable to FIG. 1.

For this purpose, besides the internal side surface 116a of the sash profile 116, the edge surface 124c of the outer visible part or the seal 730 arranged thereon is also disposed at the height A-A. The surfaces are substantially in a common plane or at the same height (A-A) and yield a common surface extending through the panel or a frame which apparently extends through the frame. An arrangement of the inner surface 720d of the edge seal of the panel substantially in this plane or slightly below the plane further reinforces the impression.

In contrast to FIG. 1, the outer visible part 124 additionally surrounds the inner blind frame profile and has a stabilising or reinforcing indentation 740 of the cavity 735. The shape of the first seal 730 differs inter alia from the seal 130 shown in FIG. 1. However, it is no longer possible for the heights h₁ and h₂ from FIG. 1 to coincide, on account of the structural differences.

FIG. 8 shows a horizontal section through another embodiment of a composite frame according to the invention with an openable window and an adjacent fixed area window, the section extending through a so-called post region. In the embodiment shown in FIG. 8 only one of the two windows (the window 820.1 shown on the left in FIG. 8) can be opened with a sash frame 814.1, whereas the window 820.2 on its right is fixedly attached to the blind frame 812 and is thus fixed and cannot be opened. The post region in the embodiment shown is made up of the outer visible part 824 and the blind frame profile 822 of the openable window. The outer visible part 824 and the blind frame profile 822 in the post region shown provide an additional receptacle for the adjacent fixed area window 820.2. The composite frame 810 shown in FIG. 8 is thus designed to receive 2 windows side-by-side which adjoin one another via the outer visible part 824 of the blind frame 812. For fixedly connecting the fixed area window 820.2 to the blind frame 812, in the embodiment shown the panel 820.2 is spanned between a compression seal 841 and a section of the outer visible part 824. Obviously, the fixed area window 820.2 may also be constructed as an openable sash. In this case the blind frame 822 and the outer visible part 824 (in the area shown) are constructed as a face-plate.

The essential differences between FIG. 8 and FIG. 4 are in the alternative embodiment of the outer visible part 824 and the fixed attachment of the fixed-area window to the blind frame without the use of an adapter profile for the fixed-area window. Obviously, the panel of the fixed area may also be mounted on the blind frame by means of an adapter profile.

FIG. 9 shows a cross-section/vertical section similar to that in FIG. 1, through another embodiment of a window with a composite frame 910 according to the invention in the installed state. FIG. 9 differs from FIG. 1 essentially in the attachment of the outer visible part 924 to the blind frame profile 922 by means of a screw fixing 923 (indicated by dotted lines). The screws used for this, in contrast to FIG. 1, extend through a partial region of the outer visible part 924 into the blind frame profile 922. In the embodiment shown, the indentation 940 in the outer visible part 924 is used as the point of entry into the outer visible part 924. Other essential differences from FIG. 1 are the additional embodiments of the first seal 930 and of the insulation 936.

FIG. 10 shows a horizontal section similar to FIG. 4 through another embodiment of a composite frame 1010 according to the invention with two windows 1020.1, 1020.2 arranged side-by-side, the section going through the face-plate region 1025. FIG. 10 shows another embodiment of the outer visible part 1024 for use with two windows arranged side-by-side. Moreover, the first seals 1030.1, 1030.2 are constructed according to another embodiment.

The outer visible portion engages in the adapter profile 1018.2 in the embodiment shown. For this purpose a defined spacing (e.g. 0.2 mm) is provided between the adapter profile 1018 and the outer visible part 1024 at the locations 1060.

FIG. 11 shows a horizontal section similar to FIG. 3 through a composite frame 1110 according to the invention that integrates two adjacent windows, in the region of the post. FIG. 11 shows another embodiment of the outer visible part 1124 for use with two windows arranged side-by-side. Moreover, the first seals 1130.1, 1130.2 are constructed according to another embodiment.

FIG. 12 shows a cross-section/vertical section similar to

FIG. 9 through another embodiment of a window with a composite frame 1210 according to the invention and a double glazing panel 1220.

FIG. 13 shows a cross-section/vertical section similar to FIG. 12 through another embodiment of a window with a composite frame 1310 according to the invention and a double glazing panel 1320. The double glazing panel shown has an additional insulating layer on its surface on the outside of the building or a greater thickness of the glass compared with FIG. 12.

FIG. 14 shows a cross-section/vertical section similar to FIG. 13 through another embodiment of a window with a composite frame 1410 according to the invention and a double glazing panel 1420. The double glazing panel 1420 shown has an additional insulating layer on its surface on the outside of the building or a greater thickness of glass compared with FIG. 13.

FIG. 15 shows a cross-section/vertical section similar to FIG. 12 through another embodiment of a window with a composite frame 1510 according to the invention and insulating glass panel with two chambers 1520.1, 1520.2. The insulating glass panel has a greater thickness of glass compared with the figures described above. For accommodating the glass panel, in the embodiment shown, the adapter profile 1518 is of suitable dimensions and the sash profile 1516 is constructed with a suitable recess.

The invention thus opens up the possibility of constructing windows with very slender, weather-proofed frame profiles while at the same time providing a high insulation effect. The fixed connection between the panel 120, the adapter profile 118 and the sash profile 116 makes it possible to reduce the visible width of the composite frame compared with conventional window constructions, so that a narrow frame width can be achieved. The construction of the outer part of the blind frame 112 protects the wood elements on the inside (sash profile and blind frame profile) from weathering. The use of GRP for the adapter profile 118 and the outer visible part 124 of the blind frame 112 significantly improves the heat transfer coefficient of the frame compared with conventional wood/aluminium windows. In particular, the low heat conduction of GRP ensures that there are no thermal bridges in the frame cross-section.

1.-29. (canceled)

30. Composite frame for insertion in a building aperture, comprising a blind frame and a sash frame hinged to the blind frame, wherein the sash frame comprises an inner sash frame profile and on an outward facing side of the inner sash frame profile an adapter profile fixedly connected to the inner sash frame profile for the fixed insertion of a panel provided for this purpose, wherein a middle portion of the adapter profile is fixedly connected to an edge seal of the panel and wherein the blind frame comprises an inner blind frame profile essentially surrounding the inner sash frame profile and wherein on a side of the inner blind frame profile on the outside of the building is provided an outer visible part fixedly connected to the inner blind frame profile.

31. Composite frame according to claim 30, wherein the panel is connected substantially around its periphery to the adapter profile.

32. Composite frame according to claim 30, wherein the panel is glued to the adapter profile.

33. Composite frame according to claim 30, wherein the fixed connection of the adapter profile to the inner sash profile and the fixed connection of the outer visible part to the inner blind frame profile are carried out by screwing and/or gluing.

34. Composite frame according to claim 30, wherein the outer visible part is essentially made of a material selected from among plastics, PVC, fiber-reinforced plastics, particularly glass fiber-reinforced plastics (GRP) and carbon fiber-reinforced plastics (CFRP), mineral materials, wood composite (Fibrex™) or a metal or metal alloy, particularly aluminum and aluminum alloys.

35. Composite frame according to claim 30, wherein the inner sash frame profile and the inner blind frame profile are each made of a material selected from among wood, plastics, PVC, fiber-reinforced plastics, particularly glass fiber-reinforced plastics (GRP) and carbon fiber-reinforced plastics (CFRP), mineral materials or wood composite Fibrex™.

36. Composite frame according to claim 35, wherein the inner sash frame profile and the inner blind frame profile are made of the same material and provide surfaces on the room side of uniform appearance.

37. Composite frame according to claim 30, wherein the outer visible part essentially comprises a surface on the outside of the building which is the only surface of the composite frame open to the weather or exposed to it.

38. Composite frame according to claim 30, wherein the outer visible part comprises a first seal which is arranged between the outer visible part and the panel or between the outer visible part and the adapter profile and in a closed state of the composite frame seals the outer visible part relative to the panel or the outer visible part relative to the adapter profile.

39. Composite frame according to claim 30, wherein the outer visible part has a cavity, the cavity being filled with air or a thermal insulating material which is selected from among gases, insulating foam, insulating wool or other suitable insulating materials.

40. Adapter profile for use in a composite frame 5 for fixed connection to a panel and for fixed connection to a sash frame profile, wherein a middle portion of the adapter profile is fixedly connected to an edge seal of the panel.

41. Adapter profile according to claim 40, which comprises a middle portion for connecting the adapter profile to the panel and at least one first leg for connecting the adapter profile to the sash frame profile, which is arranged at a first end of the middle portion.

42. Adapter profile according to claim 41, wherein the first leg is arranged on the middle portion such that the adapter profile substantially comprises an L-shaped or a T-shaped cross-section.

43. Adapter profile according to claim 40 which is constructed for the mounting of a seal that seals off the adapter profile relative to a blind frame surface of the composite frame.

44. Adapter profile according to claim 41 which comprises at least one second leg which is mounted on a second end of the middle portion opposite the first end.

45. Adapter profile according to claim 44, wherein the second leg is mounted on the middle portion such that the adapter profile essentially has a Z-shaped, U-shaped or h-shaped cross-section.

46. Adapter profile according to claim 40, which is essentially produced from a material selected from among fiber-reinforced plastics, particularly glass fiber-reinforced plastics (GRP) and carbon fiber-reinforced plastics (CFRP).

47. Composite frame according to claim 30, comprising an adapter profile.

48. Composite frame according to claim 30, comprising a second seal which is mounted on the adapter profile and structurally acts on a surface of the outer visible part arranged inside the composite frame.

49. Composite frame according to claim 30, wherein an inner side surface of the sash profile and an edge surface of the outer visible part and/or an edge surface of the first seal are arranged substantially in the same plane and form a common surface extending through the panel or a frame extending through the panel, the inner side surface of the sash profile abutting on the panel.

50. Composite frame according to claim 30, wherein the outer visible part and the adapter profile are produced from glass fiber-reinforced plastics (GRP).

51. Composite frame according to claim 30, having a blind frame comprising two frame openings, wherein the two frame openings are separated by a post formed in the blind frame, and with two sash frames each of which is associated with one of the frame openings.

52. Composite frame according to claim 30, with a blind frame comprising a frame opening, the frame opening comprising two sash frames and the two sash frames being connected in the closed state of the composite frame by a face-plate formed on one of the two sash frames.

53. Composite frame according to claim 51, wherein the two sash frames are openable.

54. Composite frame according to claim 51, wherein one of the two sash frames is openable and the other one of the two sash frames is of fixed construction.

55. Composite frame according to claim 30, wherein the adapter profile is partially connected to the panel at any desired number of partial areas or has any desired number of interruptions.

56. Composite frame having an adapter profile according to 40, wherein the adapter profile is attached to a building directly or indirectly without a blind frame.

57. Window comprising a composite frame according to claim

58. Door comprising a composite frame according to claim 30.

59. Process for producing a composite frame for insertion in a building aperture, comprising the following steps:
preparing a panel and an adapter profile,
fixedly inserting the panel in the adapter profile or fixedly connecting the panel to the adapter profile to provide a rigid self-supporting unit, and
fixedly connecting the adapter profile or the rigid self-supporting unit to an inner sash frame profile,
wherein a middle portion of the adapter profile is fixedly connected to an edge seal of the panel.

60. Process according to claim 59, wherein the step of fixedly inserting the panel in the adapter profile or fixedly connecting the panel to the adapter profile takes place before the fixed connection of the adapter profile or the rigid self-supporting unit to the inner sash frame profile.

61. Process according to claim 59, wherein the panel is connected to the adapter profile substantially around its periphery.

62. Process according to claim 59, wherein the panel is glued to the adapter profile.

63. Process according to claim 59, wherein the fixed connection of the adapter profile to the inner sash profile is carried out by screwing and/or gluing.
